(19) United States
(12) Patent Application Publication
(10) Pub. No.: US 2004/0167897 A1
(43) Pub. Date: Aug. 26, 2004

(54) Data mining accelerator for efficient data searching

(75) Inventors: Charles E. Kuhlmann, Raleigh, NC (US); Ann M. Rincon, Burlington, VT (US); Norman C. Strole, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/373,811

(22) Filed: Feb. 25, 2003

(51) Int. Cl. G06F 17/30

(52) U.S. Cl. 707/10

(57) ABSTRACT

A data mining accelerator is used with network processor technology to enable real time pattern searching of large databases. The classification and search capability of a processor element array inside the network processor is used to format database records having variable length fields in random order into ordered data packets containing fixed length fields. The contents of the fields are hashed and formatted into binary key values. Searching can be by parallel processing of multiple database records or distributed processing of a single record for multiple match conditions. A classification engine is used to sort records from a single database into separate streams based on one or more special fields, or to sort records from different databases into separate search streams for routing to search engines dedicated to each stream. The search engine collects and matches statistics in real time or searches for new, statistically significant match conditions.

### FIELD OF THE INVENTION

This invention relates to the analysis of large information databases to locate all records that match a dynamic set of user-defined criteria or to identify new correlations and new trends.

### BACKGROUND OF THE INVENTION

Large databases are used to maintain inventory records, such as descriptions of cars for a large dealership, product records for a large retailer, real estate property listings, or population demographics. High-speed database servers rely upon fast search algorithms to quickly search through a large inventory database to find all items that match a given set of criteria.

A practice called data mining is an important tool for identifying and extracting useful information from large relational databases, thereby facilitating an important quantitative activity within consumer product marketing and retail sales. This information can then be intuitively analyzed and interpreted to detect patterns and to make judgments based on correlations among diverse elements of the extracted information.

Suppliers for consumer products have to focus their sales and distribution efforts on smaller and smaller segments of the population in order to maintain market growth and take market share away from the competition. Over the past decade, major consumer product suppliers have been giving the customer more choices of sub-products within a product family, like toothpaste. Their goal is to increase total share within an established commodity market by offering customers products which exactly fit their needs. For similar reasons, retail store chains are learning new ways to stock consumer products to maximize shelf visibility and convenience on a per customer, per season basis. Both groups are accessing the massive amount of data that is continuously being collected surrounding consumer demographics and buying habits, and using this information to identify consumer buying trends to help focus their sales and marketing efforts. The speed at which suppliers and retailers, large and small, can identify and react to new information in this area has become an important factor towards the success of their businesses against increasing, worldwide competition. The consumer products and services industry is constantly looking for faster and better ways to analyze huge amounts of customer data to come up with new correlations and new trends across different types of consumers, different local sales areas, different times of the year and between different product categories. The ultimate goal is to collect, analyze and respond to changes in the database in real-time.

Outlined below are three examples of data mining:

1. An inventory database contains a set of records that describe the characteristics of each item in the inventory. For example, a large car dealership may have hundreds of automobiles with various choices of models, colors, options, etc. The descriptive record for each individual car can have the same format with several fields. The records can then be scanned for various combinations of criteria (e.g., a subset of specific fields), such as: (a) model=sedan (b) color=blue (c) price<$15K (d) interior=cloth (e) option=CD player, etc.

2. A patient database contains records for thousands of patients. The descriptive record for each patient can have the same format. The records can be scanned for various combinations of criteria, such as: (a) sex=male (b) age=35<45 (c) diagnosis=flu (d) treatment=xx, etc.

3. A database contains records for thousands of homes throughout the country.

The records can be scanned for various combinations of criteria, such as: (a) location=Raleigh (b) BR=4 (c) garage yes (d) style=ranch (e) size=1500<2500 sq ft.

All three of these examples of data mining, as well as most other types of data mining, can benefit from the technology of the present invention.

### BRIEF DESCRIPTION OF THE INVENTION

The present invention provides faster and more efficient methods to analyze large information databases to locate all records that match a dynamic set of user-defined criteria or to identify new correlation and new trends across different types of consumers, different local sales areas, different times of the year, and between different product categories. This invention also describes a data mining accelerator which can be used with conventional application server technology to enable real time pattern searching for terabit speed, terabyte size databases.

The classification and search capability of a processor element array inside the network processor is used to format database records having variable length fields in random order into ordered data packets containing fixed length fields in strict order. The contents of the fields of interest within a database record are hashed to reduce their size to a binary key value which is passed to a key search engine implemented in hardware. The hashing can be carried out using any of a number of algorithms that are available for that purpose. The key is put into a search table representing combinations of fields in the database record. The key is useful for the search of the database record as well as for routing of packets in a network processor.

Searching can be by parallel processing of N database records using N separate search engines and one match counter per search table entry. Alternatively, searching can be conducted by distributed processing of a single record for M match conditions using M match counters. A classification engine is used to sort records from a single database into separate streams based on one or more special fields, or to sort records from different databases into separate search streams routed to search engines dedicated to each stream. The search engine is used to collect and match statistics in real time as new records are added to a database. The search engine can also search for new, statistically significant match conditions, by searching for all combinations of a set of fields and comparing match counter values to predetermined threshold values.

The invention relates to a computer readable medium containing instructions for searching one or more database records. The instructions comprise (a) formatting a database record containing variable length fields in random order into a data packet containing fixed length fields in strict order. This is then followed by (b) randomly dispatching the formatted record to one of several separate search engines. The process of formatting and dispatching of new records is repeated in real time as they are added to a database. The instructions preferably are carried out in a network processor.

The invention also relates to a system and a method for analyzing at least one information database utilizing a network processor. First, a searchable database record table is provided comprising at least one data packet containing fixed length fields in fixed order. Next, criteria are established for a search through the record table. Then, at least one classification record is constructed to match the criteria. Finally, an action to be taken is determined based upon a positive or a negative criteria match.

### BRIEF DESCRIPTION OF THE DRAWINGS

FIG. 1 is a flow diagram for a match search process;

FIG. 2 is a flow diagram of a network processor performing parallel searches;

FIG. 3 shows the flow of database records into a classifier for a hash function;

FIG. 4 is a flow diagram for data mining of a directed search;

FIG. 5 is a flow diagram for searching for new correlations within a stored database;

FIG. 6 is a flow diagram of a code running in a packet engine;

FIG. 7 shows the mapping from a header record to a searchable database; and

FIG. 8 shows a computer-readable medium for data mining according to the present invention.

### DETAILED DESCRIPTION OF THE INVENTION

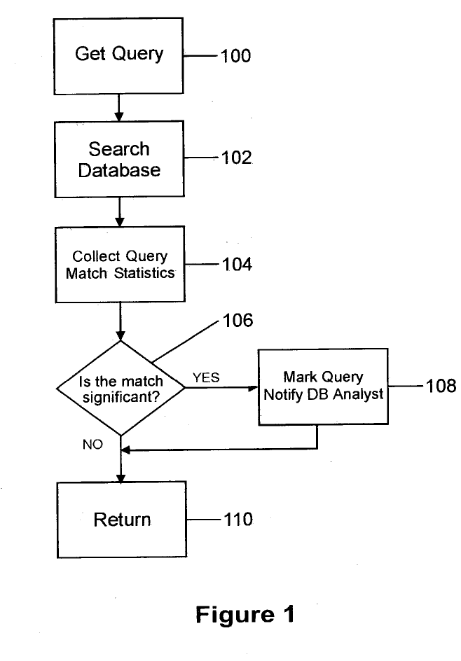

Turning now to the drawings, FIG. 1 shows a high level flow for a match search process. A typical database may be scanned several times within a short time interval to search for all items within the database that match a user-defined set of criteria. The first step 100 comprises getting a query, followed by the next step 102 of searching a database. The match statistics are collected in the next step 104. Each match is scanned in step 106 to determine its significance. If the match is determined to be significant, it is marked for analysis in the next step 108. If the match is determined not to be significant, it is returned in step 110 to the first step 100.

A network processor typically contains the firmware mechanism for packet classification schemes that are primarily designed for network packet routing and switching applications. The functional blocks of such a network processor are shown and described in greater detail on pages 27-39 of a public document entitled “IBM PowerNP™ NP4GS3 Network Processor”, the relevant portions of which are incorporated herein, and made a part hereof. A control processor handles initialization, table updates and special packet processing tasks. An input queue is associated with the network processor such that the utilization of packet processors can be determined by looking at the arrival rate of packets into the queue. There is a packet dispatcher in the NP with the goal of distributing the packet workload evenly across all packet processors. Packets are received into packet memory and are enqueued to a group of programmable processor elements (PPE). One unique aspect of the NP is that these multiple processor elements are able to execute in parallel on multiple packets simultaneously. An NP will typically contain dozens or even hundreds of these processor elements as a means of boosting the performance of the NP by spreading the packets across the processors in a multiprocessing approach. Each of these processor elements can perform operations in parallel on fragments of the same packet or they can operate on multiple packets in parallel. This capability makes it possible to significantly accelerate the data scan process with an NP. The programmable capability of the NP facilitates the customization of search parameters and other packet handling functions for added flexibility. A network processor can rapidly classify thousands of packets per second to expedite the frame filtering and forwarding functions. The classification may be accomplished entirely via the programmable processors or may be accomplished with a combination of unique hardware-assist coprocessors and programmable processors.

With packet routing, there is apriori knowledge about the format of packet information, such as the offset of the IP address and TCP (transmission control protocol) header fields, so that the frame classification and lookup operations against tables of addresses can be expedited. Likewise, the scanning of database information records for gathering statistics, trends, etc. will be most efficient if field locations and records of target match patterns are established in advance. Thus, the database record table must be generated in advance of the database search to reflect the content that is to be captured by the scan operation. The database search process may be as follows:

The user, having apriori knowledge of the database record formats and field contents, constructs the table(s) to match the criteria for a search against the database. The user also determines the actions to be taken for each positive criteria match or exception condition (e.g., no criteria match in database).

The database records are stored in memory or a disk storage device that is accessible directly by the network processor or indirectly via the general purpose processor (GPP). These database records must be retrieved from the memory or storage device and passed to the NP as a preformatted frame that is recognized by the NP hardware. The preformatted information is compared against a user-defined classification record. With this scheme, thousands of records can be examined against a given set of classification criteria.

The NP may perform one or more classification operations associated with each frame. These operations may be performed by one or more modes, such as

Serial processing of the database record, with sequential classification operations based upon a comparison of various fields within the frame against the search criteria, or

Parallel processing of the database record, with multiple classification operations occurring simultaneously, with each operation based upon a unique subset of the fields within the frame.

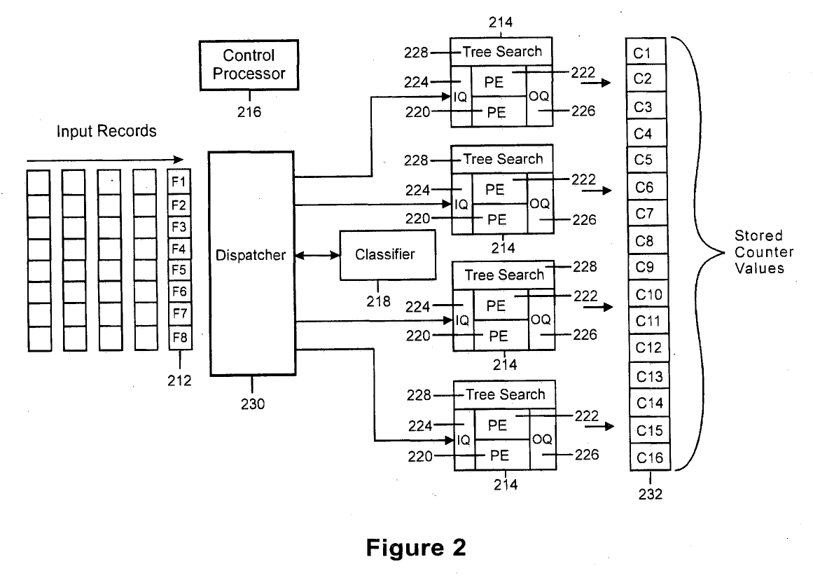

FIG. 2 shows a simplified diagram of the NP functions referenced by this invention. A control processor 216 performs various functions to be hereinafter described. The packet engine (PE) blocks 214 are the programmable processor elements (PPEs) previously described. Each pair of packet engines 220, 222 shares an input queue, IQ 224, an output queue, OQ 226, and a tree search engine 228. A dispatcher 230 routes record fields or packets (F1-F8) 212 coming into the NP to a classifier 218 that contains a hash function which generates a fixed length key that is returned to the dispatcher. From there, the hashed records go to one or more packet engine blocks 214 based on a queuing algorithm set by the control processor 216. The queuing algorithm can set the performance mode of the NP search engine by determining whether multiple PEs will be used to process different fields of the same record or whether records will be routed to different PEs in a round robin fashion. Each tree search engine 228 has its own tree search table (not shown). This table is constructed from a list of match entries where each entry contains one or more fields representing, for example, product identifiers from one or more product categories. Each entry, for example, contains the same set of categories in the same order. The match entries are compiled and are hashed or transformed into unique keys to locate the counter values C-C16. These are stored in the search table 232 which is loaded into the memory associated with each PE block 214 by the control processor 216.

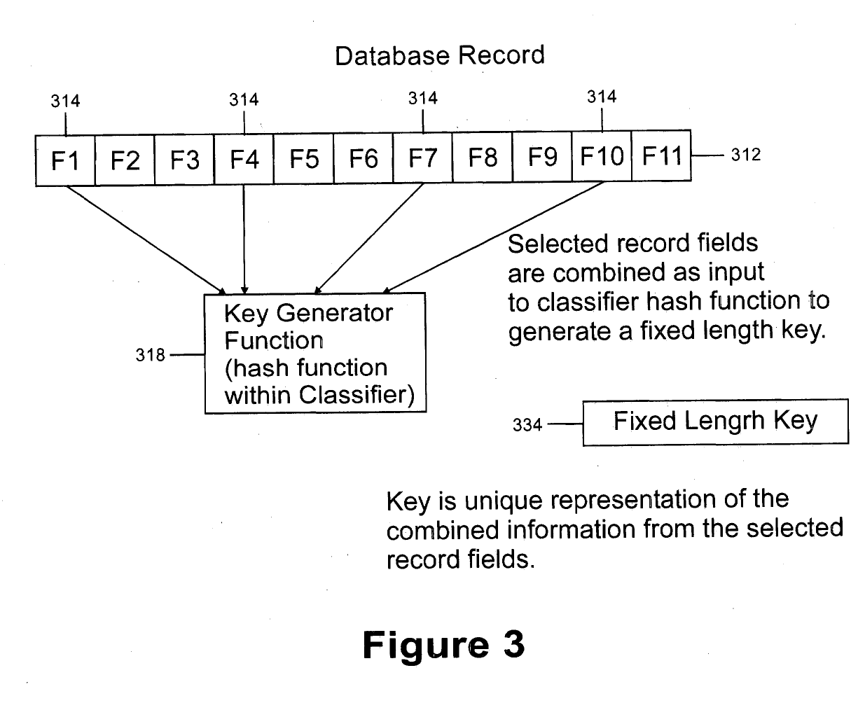

FIG. 3 is a simplified diagram explaining the hashing of record fields F1-F11 (312). The record fields are combined as input to the hash function 318 within the classifier (218) of FIG. 2. The record fields are algorithmically processed into one or a plurality of keys of fixed length 334, e.g. 32 bits, 64 bits, etc., each uniquely representing combinations of fields within the database records to combine information from these various fields. The keys are then returned to the dispatcher 230 of FIG. 2. Any one of several mathematical algorithms can be used for the purposes of reducing the fields down to individual keys.

Searching Different Groups of Categories

The packet engine blocks 214 shown in FIG. 2 each have separate tree search engines and separate tree search tables. The same tree search table can be duplicated for all tree search engines. This is the NP performance mode of operation where the dispatcher distributes records evenly across all of the packet engine queues. For this mode, every packet engine is running the same instructions and looking for the same match conditions within the same item categories. There is a second mode supported by the NP where each packet engine block can be programmed to search through a different list of matches for a different set of categories. For example, packet engine block A can be loaded with tree search table A and packet engine block B can be loaded with tree search table B. The two search tables do not have to be identical. Search table A can be built from two categories, e.g. color and body style. Search table B can be built from any other grouping of categories, e.g. day of week, gender, price and style. The two search tables can be built from a different number of categories with different categories in the match set. In this configuration, the dispatcher sends search keys generated from the same record to the input queues for both packet engine blocks. Each PE block searches through a different set of match conditions and updates a different set of counters.

A third mode of operation of the NP allows it to divide the input stream of records into multiple flows. This can be desirable if the database analyst wants to separate correlation data according to some field in the record header, like day of the week. The classifier 218 in FIG. 2 is used by the record dispatcher 230 to distinguish between records gathered on different days of the week, for example, and separates them into multiple flows. Flow A, corresponding to grocery store transactions processed on Monday, is routed by the dispatcher to one or more packet engine blocks using counters dedicated to Monday data. Flow B, corresponding to Tuesday's transactions, is routed by the dispatcher to one or more packet engine blocks using counters dedicated to Tuesday data, and so on. In this case, the packet engine blocks can be searching through the same grouping of categories; however, the entries in search table A point to a different set of counters from the entries in search table B, etc.

Another use of this third mode can be to search through a heterogeneous set of records. In this case, the searchable records that are sent to the NP do not all represent the same total set of item categories. For instance, some records could have been processed from grocery store transactions and some records could have been processed from hardware store transactions. Again, the record header contains one or more fields which distinguish between the two types of records and the classifier can use this information to divide the records into two flows. The dispatcher can send Flow A records to one or more packet engine blocks programmed to match on grocery store product categories. Flow B records can be sent to a different set of one or more packet engine blocks programmed to match on hardware store categories. The search table used by Flow A packet engines is built from a different group of categories with different values from the search table used by Flow B packet engines.

This invention addresses two basic processes involved with statistical data mining; (A) searching of known statistically valid relationships in “real-time” (while new records are being added to the database), and (B) searching for new statistically valid relationships to add to the list for process A.

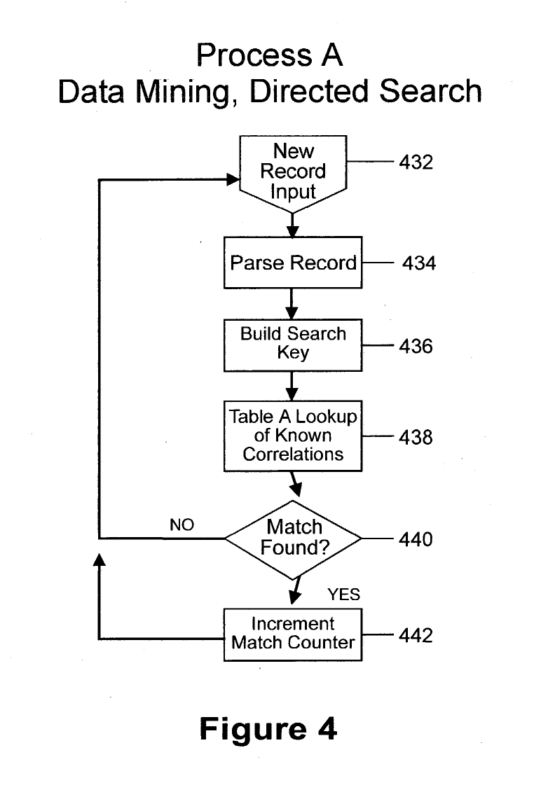

Process A in FIG. 4 assumes that information already exists about groupings of data values from two or more item categories which are considered statistically significant. Process A also assumes that each grouping in this match list or table contains values from the same item categories, e.g. color and style. In process A, fixed size records are scanned as they are being forwarded to the database, and a separate count is maintained for all match occurrences for each group of values in the list. The counts can be compared to high and low threshold values to trigger alerts when known activity falls outside of predetermined ranges for a given period of time. The benefits of process A are that match data collection, threshold detection, and significant deviation alerts all are in real time. The size of the match list is equal to the number of value groupings that need to be tracked. The field length of each entry in the match list (all entries must be the same length) is equal to the key length of the number of categories, 2, 3, 4, etc., which need to be grouped together for a match. Each entry also contains a pointer to an object, usually lo a counter location, to be acted on as a result of a positive match. New records are input at step 432. The records are parsed at step 434 to select the number of categories to be searched. The categories are hashed at 436 to build the keys of 16 bits, 32 bits, etc. based on the number of categories that are to be picked for inclusion in each key. The key is then used at 438 to look for correlations in Table A. If a match is found at 440, the match counter is incremented by 1 at 442. This directed search can also be carried out in parallel by building two keys based on the same data base and passing the two keys to two network processors to do two lookups in parallel against the same database. Three or more parallel searches can likewise be conducted the same way by building that number of keys and passing each key to a separate network processor to search the database.

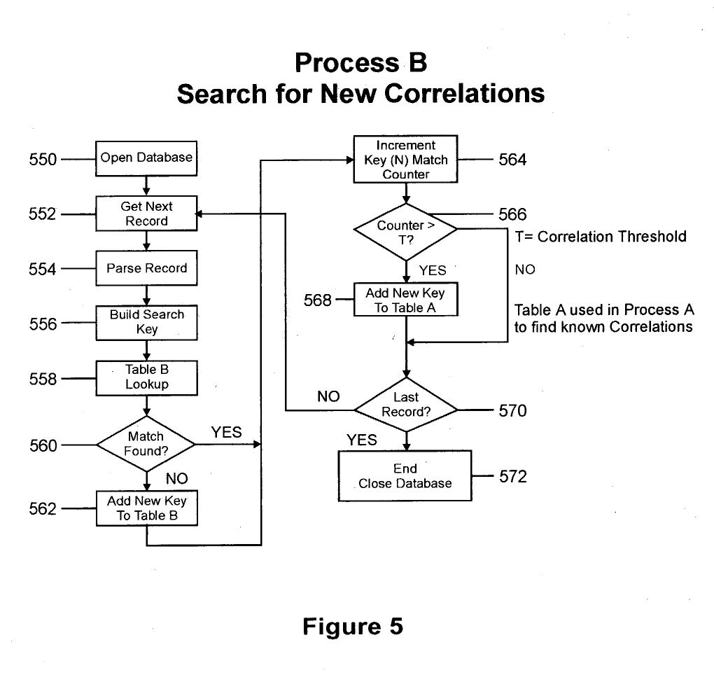

Process B in FIG. 5 shows how to carry out a search for new, statistically valid groupings of data within a stored database. New, possibly significant activity corresponds to value groupings which do not match any of the groups in the known list. Process B can keep a count of records whose groups of item categories contain the same values. If any of these “new match” counts exceeds a threshold value indicating statistical significance to the data analyzer, then that new value group is added to the list used by process A (FIG. 4), to be monitored in real-time. The list used for process A can be updated at certain intervals, i.e. once a day, to reflect the new collection of statistically valid relationships. In this way, the two processes complement each other and result in a combined process which tracks known relationships and seeks out new relationships.

A match search involves creating a key from a database record using fields corresponding to the same categories used in the search table. The search engine attached to the PE block is a specialized coprocessor which takes a key from a database record and returns the value contained in a leaf of the search table which matches the input key. If no match is found, then a null value is returned. The value that is returned following a match condition can be a pointer to other operating elements, such as a stored counter location and other stored variables.

Process B commences the opening of a database 550 to get the next record 552. The record is parsed at 554 to select the categories to be searched. The categories are hashed to build a search key 556. Table B is then searched (558) to see if the key is already matched (560) in the table. If the key is found, the key counter is incremented by 1 at 564, and the counter value is compared with T, a correlation threshold. If the counter is greater, the new key is added to table A 568 for a directed search. If the counter is less than or equal to T, then no operation is performed on Table A and the process is repeated with the next record. If this is the last record, the database is closed 572.

Analysis of Consumer Purchases

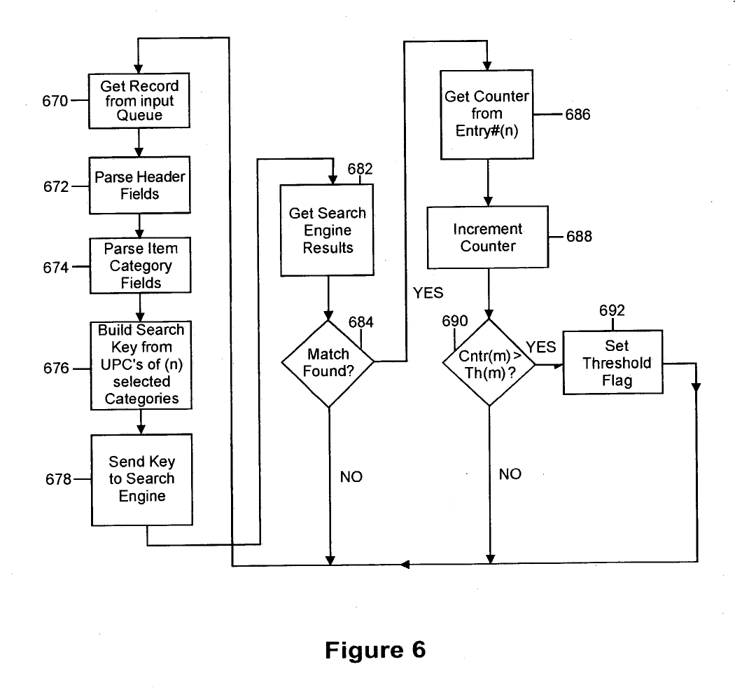

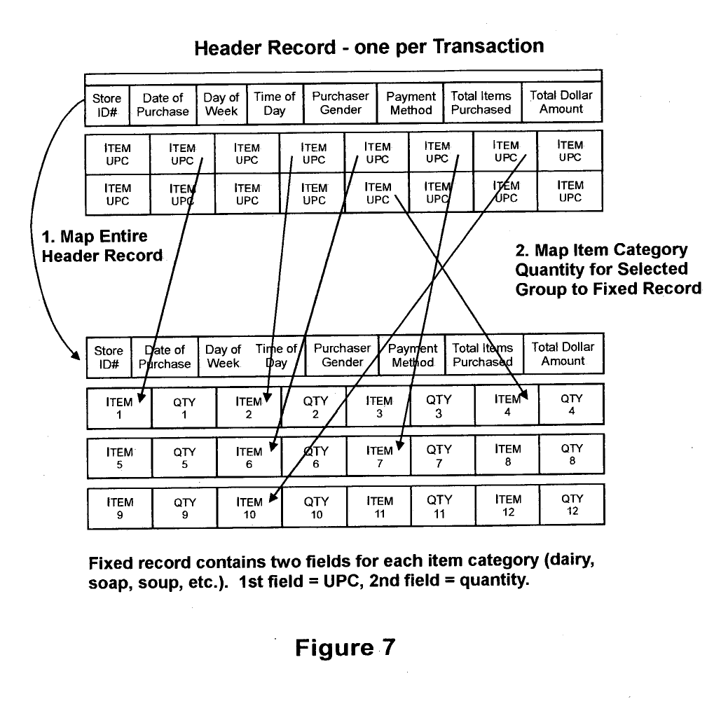

The same system can be used to identify consumer purchasing patterns in the retail industry. For example, analysis of consumer buying patterns in a supermarket can lead to more effective advertising or product placement. The typical transaction differs from the criteria described in the previous database mining examples in two key elements. Individual customer orders (e.g., shopping cart) vary in both number of items purchased as well as the types of items purchased. The use of a network processor for enhanced data mining applications in this environment can be accomplished by first creating a structured database that contains records that can be searched more efficiently. One method for accomplishing this as shown in FIGS. 6 and 7 wherein a batch search is carried out through an existing database looking for user-directed matches.

FIG. 6 is a flow diagram of the code running in each packet engine. The coding makes use of an item quantity field paired with each item category field in the packet. In the first step 670, a record is obtained by a search engine from its input queue. The header fields of the record are parsed at 672 in the manner shown in FIG. 3 to select the categories to be searched. Next, the item categories are parsed (674) and search keys are built at step 676 from a certain number (n) of selected categories of product identifiers which, in the case of retail items, can appropriately be identified by the UPC (Universal Product Code). The keys are then sent at step 678 to the search engine and the search results are obtained at 682. If a match is not found at 684, then the next record is obtained from the input queue at 670. If, on the other hand, a match is found, the counter is obtained at 686 and in 688 is incremented to show a new counter value equal to the previous counter value +1. This new value is then compared at 690 with the high threshold value Th(m). If this new counter value is greater than the high 5 threshold value Th(m), a new upper threshold flag is set in 692. Then the next record in the input queue at 670 is parsed and searched in the same manner. If the counter value is not greater than the high threshold value, the threshold flag TA(m) is not set, and the next record is parsed and searched. A different control processor application can periodically query the NP for the contents of all of the threshold flags. Any threshold flag number that is set, Th(m), indicates that the same entry number, m, within a list of category match entries has met the threshold requirement to be considered a “true” correlation between the associated product categories.

This procedure shown in FIG. 6 can be used to preprocess individual customer records to capture specific items of interest. It assumes that there are a predetermined set of items or categories to be tracked. Some customers may purchase only one or two items from those that are being tracked, others may purchase a larger number of the items, and still others may not purchase any items of interest. A customer transaction record includes the UPC (uniform product code) identifier for all items purchased in random order. Each record also contains a header that describes general information about the transaction, such as a date/time stamp, the gender of the customer, the purchase location, total dollar value of the transaction, and total number of items purchased.

The structure for the searchable database records used in FIG. 6 is shown in FIG. 7, with the item fields organized in order by item category, e.g. diary, soup, soap. It is important that all searchable records have the same format, list the same number of categories and list the item categories in the same order. A separate index is maintained by the pre-processor which maps the specific item universal product code to an item category. The items which fit into the categories of interest are stored into the appropriate position in the searchable record. Each category position requires two data fields to store the item UPC and the item quantity. The record header and the items that are being tracked are mapped from the customer transaction record to the searchable database record. A null or zero entry would indicate that no items within that category were included in the transaction. Once the formatted, searchable transaction records have been created, the network processor application can execute a variety of simultaneous scans to determine trends or buying patterns for specific days of the week, time of day, item mix versus size of order, item mix versus gender of customer, etc.

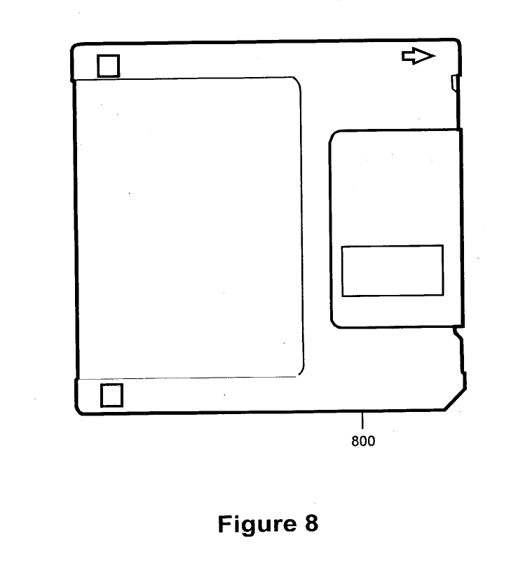

FIG. 8 shows a floppy disc 800 for containing the software implementation of the program to carry out the various steps of the present invention.

While the invention has been described in combination with specific embodiments and examples thereof, there are many alternatives, modifications, and variations. For example, the present invention can be used by the credit card, telecommunication and insurance industries to search database records, to parse the records, to hash the records into searchable packets and to extract specified information from the databases. Accordingly, the invention is intended to embrace all such alternatives, modifications and variations as fall within the scope and spirit of the appended claims.

What is claimed is:

1. A computer readable medium containing instructions for searching one or more database records, said instructions comprising:
a. Formatting database records containing variable length fields in random order into searchable data packets containing fixed field length in fixed order;
b. Randomly dispatching the data packets to one of several separate search engines, and
c. Repeating the formatting and dispatching of new records in real time as they are added to a database.

2. The medium according to claim 1 wherein the instructions are carried out in a network processor and the search engines utilize multiple processor elements within the network processor.

3. The medium according to claim 1 wherein the instructions determine whether searching will be carried out by parallel processing of multiple data packets using multiple search engines or by distributed processing of a single data packet for multiple match conditions using multiple match counters.

4. The medium according to claim 1 wherein the instructions control a classification engine for generating a search key.

5. A method for analyzing at least one information database comprising:
a. Providing a searchable database record table comprising a data packet containing fixed length fields in fixed order;
b. Establishing criteria for a search through the record table;
c. Constructing at least one classification record to match the criteria; and
d. Determining an action to be taken as determined by a positive or a negative criteria match.

6. The method according to claim 5 wherein the database analysis is conducted on a network processor.

7. The method according to claim 6 wherein a variable field length randomly ordered database record is formatted into said searchable fixed field length data packet in fixed order.

8. The method according to claim 6 wherein the records in the record table are preclassified using one or more of the fixed length fields into separate record streams, and the streams are dispatched to separate search engines.

9. The method according to claim 8 wherein the records are preclassified by generating fixed length keys using a hashing scheme.

10. The method according to claim 6 including the further step of conducting real-time searching of new records as they are added to the database record table.

11. The method according to claim 6 further including the step of identifying new correlations or trends among selected data records for future comparison.

12. The method according to claim 6 wherein the database record table is searched based on the criteria established for the search.

13. The method according to claim 6 wherein the database record is searched either by parallel processing or by distributed processing.

14. A system for analyzing at least one information database comprising:
a. a searchable database record table comprising a data packet containing fixed length fields in fixed order;
b. criteria for a search through the record table;
c. at least one classification record constructed so as to match the criteria; and
d. a mechanism for determining an action to be taken based on a positive or a negative criteria match.

15. The system according to claim 14 comprising a network processor.

16. The system according to claim 15 including a variable field length randomly ordered database record formatted into said searchable fixed field length data packet in fixed order.

17. The system according to claim 16 including means for preclassifying the records in the table, using one or more of the fixed length fields, into separate record streams, and a dispatcher is used for forwarding the streams to separate search engines.

18. The system according to claim 17 wherein the records can be preclassified by generating fixed length keys using a hashing scheme.

19. The system according to claim 14 including the further capability of conducting real-time searching of new records as they are added to the database record table.

20. The system according to claim 15 wherein the network processor includes special hardware means for searching the database record table.

21. The system according to claim 14 further including a key search engine implemented in hardware.

22. The system according to claim 15 wherein the network processor is capable of searching the database either by parallel processing or by distributed processing.

23. The system according to claim 15 wherein the network processor uses a plurality of processor elements as packet processors.
